(19) United States
(12) Patent Application Publication
(10) Pub. No.: US 2023/0286374 A1
(43) Pub. Date: Sep. 14, 2023

(54) INTERNALLY COMPLIANT FUEL TANK

(71) Applicant: Bell Textron Inc., Fort Worth, TX (US)

(72) Inventors: Joseph Dean Rainville, Fort Worth, TX (US); Phalgun Madhusudan, Fort Worth, TX (US)

(73) Assignee: Bell Textron Inc., Fort Worth, TX (US)

(21) Appl. No.: 17/690,097

(22) Filed: Mar. 9, 2022

(51) Int. Cl. B60K 15/03; B65D 1/40

(52) U.S. Cl. CPC B60K 15/03177; B65D 1/40; B60K 2015/03046

(57) ABSTRACT

A fuel tank includes an outer wall and a compliant layer disposed within a space at least partially defined by the outer wall. An aircraft includes a fuel cell and a fuel tank having an outer wall and a compliant layer disposed within a space at least partially defined by the outer wall. A method of operating a fuel tank includes providing an external wall and disposing a compliant layer of material within a space of the fuel tank that is at least partially defined by the external wall.

### BACKGROUND

In many applications regarding providing power to electrically powered systems, providing high power density and providing lightweight sources of power are very important. For example, while batteries can provide high power density they are very heavy. In some cases, powering an electrically powered system using a fuel cell is beneficial over using batteries. However, even in systems utilizing fuel cell systems, such as, but not limited to, aircraft, the components used to enable operation of a fuel cell system also may need to be power dense and lightweight. One such component is a fuel tank for supplying hydrogen fuel to a fuel cell system. Conventional fuel tanks are very heavy, especially those utilized with expandable fuel media and there is a need for lighter fuel tanks that are used with expandable fuel media while still providing efficient heat transfer. As an example, consider one such electrically powered system, an unmanned aerial vehicle (UAV).

UAVs, or drones, are usually battery powered and are therefore limited in range by battery life. Hydrogen fuel cells are being considered as an option to extend range and flight time of UAVs. Fuel cells operate by allowing an electrochemical reaction between hydrogen and oxygen, which produces electrical energy and water. In most fuel cell powered vehicles, hydrogen fuel, stored in an onboard hydrogen fuel tank, is supplied to an anode of the fuel cell and ambient air is supplied to a cathode of the fuel cell. The electrical energy produced drives a motor and the water is disposed of. The hydrogen fuel tanks are often externally coupled to the UAV or may be housed internally within a nacelle, such as described in U.S. patent application Ser. No. 16/290,704, filed Mar. 1, 2019, which is incorporated herein in by reference in its entirety.

UAVs come in many different configurations. For example, a UAV may be configured as a conventional takeoff and landing (CTOL) aircraft or a vertical takeoff and landing (VTOL) aircraft. A CTOL aircraft generates lift in response to the forward airspeed of the aircraft. The forward airspeed is typically generated by thrust from one or more propellers. Accordingly, CTOL aircraft typically require a long runway for takeoff and landing to accommodate the acceleration and deceleration required to provide the desired lift. Unlike CTOL aircraft, VTOL aircraft do not require runways. Instead, VTOL aircraft are capable of taking off, hovering and landing vertically. One example of VTOL aircraft is a helicopter which includes one or more rotors that provide lift and thrust to the aircraft. The rotors not only enable hovering and vertical takeoff and landing, but also enable forward, backward, and lateral flight. These attributes make helicopters highly versatile for use in congested, isolated, or remote areas where CTOL aircraft may be unable to take off and land. Helicopters, however, typically lack the forward airspeed and range of CTOL aircraft. Other examples of VTOL aircraft include tiltrotor aircraft and tiltwing aircraft. Both of which attempt to combine the benefits of a VTOL aircraft with the forward airspeed and range of a CTOL aircraft. Tiltrotor aircraft typically utilize a pair of nacelles rotatably coupled to a fixed wing. Each nacelle includes a proprotor extending therefrom, wherein the proprotor acts as a helicopter rotor when the nacelle is in a vertical position and a fixed-wing propeller when the nacelle is in a horizontal position. A tiltwing aircraft utilizes a rotatable wing that is generally horizontal for forward flight and rotates to a generally vertical orientation for vertical takeoff and landing. Propellers are coupled to the rotating wing to provide the required vertical thrust for takeoff and landing and the required forward thrust to generate lift from the wing during forward flight.

Yet another example of a VTOL aircraft is a tailsitter aircraft. Tailsitter aircraft, such as those disclosed in U.S. patent application Ser. No. 16/154,326, filed Oct. 8, 2018 and U.S. patent application Ser. No. 15/606,242, filed May 26, 2017, both of which are incorporated herein by reference in their entireties, attempt to combine the benefits of a VTOL aircraft with the forward airspeed and range of a CTOL aircraft by rotating the entire aircraft from a vertical orientation for takeoff, landing, hovering, and low-speed horizontal movement, to a horizontal orientation for high speed and long-range flight.

Conventional hydrogen fuel tanks can be very heavy and comprise thick walls that are used to withstand not only gaseous pressurization but also mechanical expansion forces of some fuel components, such as, but not limited to, solid state hydride within the hydrogen fuel tanks. Accordingly, there exists a need for a lighter fuel tank that is capable of efficient heat transfer.

### BRIEF DESCRIPTION OF THE DRAWINGS

FIG. 1 is an oblique view of an unmanned aerial vehicle (UAV) according to and embodiment of this disclosure.

FIG. 2 shows a thrust module of the UAV of FIG. 1.

FIG. 3 is a cross-sectional view of a fuel tank of the thrust module of FIG. 2 according to an embodiment of this disclosure.

FIG. 4 is a flowchart of a method of operating a fuel tank according to an embodiment of this disclosure.

### DETAILED DESCRIPTION

While the making and using of various embodiments of this disclosure are discussed in detail below, it should be appreciated that this disclosure provides many applicable inventive concepts, which can be embodied in a wide variety of specific contexts. The specific embodiments discussed herein are merely illustrative and do not limit the scope of this disclosure. In the interest of clarity, not all features of an actual implementation may be described in this disclosure. It will of course be appreciated that in the development of any such actual embodiment, numerous implementation-specific decisions must be made to achieve the developer's specific goals, such as compliance with system-related and business-related constraints, which will vary from one implementation to another.

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges a UAV comprising an internally compliant fuel tank. In the least, this disclosure enables a UAV that is powered by a fuel cell that is provided fuel from an internally compliant fuel tank. This disclosure contemplates a variety of embodiments of an internally compliant fuel tank with some variations including geometry and composition of the internally compliant components. While the aircraft shown and discussed herein is depicted as a UAV, it should be understood that it may comprise any type of aircraft. Moreover, the systems and methods disclosed herein can be used on any vehicle or device that stores or otherwise utilizes hydrogen fuels, such as, but not limited to fuels comprising solid state hydride.

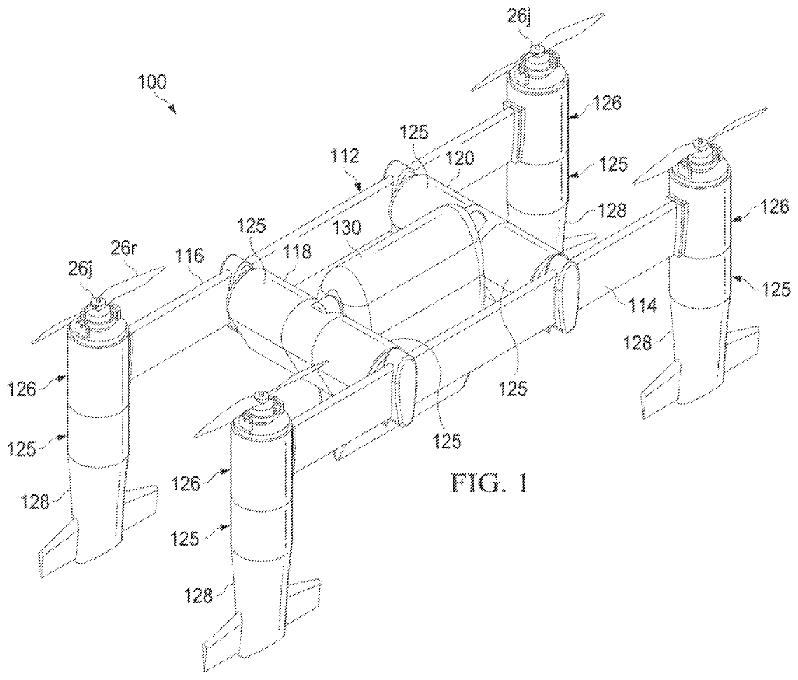

Referring to FIG. 1, a tailsitter UAV 100, operable to transition between thrust-borne lift in a VTOL orientation and wing-borne lift in a biplane orientation, are depicted. In the VTOL orientation, thrust modules 126 provide thrust-borne lift. In the biplane orientation, the thrust modules 126 provide forward thrust and the forward airspeed of UAV 100 provides wing-borne lift, enabling UAV 100 to have a high speed and/or high endurance forward-flight mode.

UAV 100 is a mission-configurable aircraft operable to provide high-efficiency transportation for diverse payloads. Based upon mission parameters, including flight parameters such as environmental conditions, speed, range, and thrust requirements, as well as payload parameters such as size, shape, weight, type, durability, and the like, UAV 100 may selectively incorporate a variety of thrust modules having different characteristics and/or capacities. For example, the thrust modules operable for use with UAV 100 may have different thrust types including different maximum thrust outputs and/or different thrust vectoring capabilities including non-thrust vectoring thrust modules, single-axis thrust vectoring thrust modules such as longitudinal thrust vectoring thrust modules and/or lateral thrust vectoring thrust modules, and two-axis thrust vectoring thrust modules which may also be referred to as omnidirectional thrust vectoring thrust modules. In addition, various components of each thrust module may be selectable including the power plant configuration and the rotor design. For example, the type or capacity of the fuel cell system in a thrust module may be selected based upon the power, weight, endurance, altitude, and/or temperature requirements of a mission. Likewise, the characteristics of the rotor assemblies may be selected, such as the number of rotor blades, the blade pitch, the blade twist, the rotor diameter, the chord distribution, the blade material, and the like.

In the illustrated embodiment, UAV 100 includes an airframe 112 including wings 140 and 160 each having an airfoil cross-section that generates lift responsive to the forward airspeed of UAV 100 when in the biplane orientation. Wings 140 and 160 may be formed as single members or may be formed from multiple wing sections. The outer skins of wings 140 and 160 are preferably formed from high strength and lightweight materials such as fiberglass, carbon fiber, plastic, aluminum, and/or another suitable material or combination of materials. As illustrated, wings 140 and 160 are straight wings. In other embodiments, wings 140 and 160 could have other designs such as polyhedral wing designs, swept wing designs, or another suitable wing design.

Extending generally perpendicularly between wings 140 and 160 are two truss structures depicted as pylons 118 and 120 that can comprise and/or carry tanks 125 for carrying fuel, such as, but not limited to, solid state hydride, for powering a fuel cell 26d. UAV 100 further comprises tail cones 128 that can serve to vertically support UAV 100 on the ground, but also, can serve to house additional fuel tanks or additional fuel.

Wings 140 and 160 and pylons 118 and 120 preferably include passageways operable to contain flight control systems, energy sources, communication lines and/or other desired systems. In the illustrated embodiment, thrust modules 126 are fixed pitch, variable speed, omnidirectional thrust vectoring thrust modules.

As illustrated, thrust modules 126 are coupled to the outboard ends of wings 140 and 160. While not shown, additional thrust modules 126 may be coupled to central portions of wings 140 and 160. Thrust modules 126 are independently attachable to and detachable from airframe 112 such that UAV 100 may be part of a man-portable aircraft system having component parts with connection features designed to enable rapid assembly/disassembly of UAV 100. Alternatively, or additionally, the various components of UAV 100.

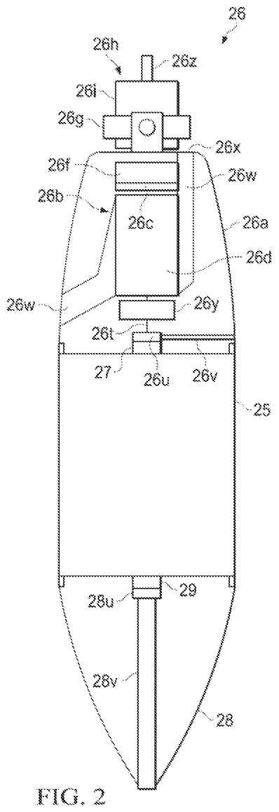

Referring now to FIG. 2, thrust module 26 for use in a UAV substantially similar to UAV 100 is shown to include a nacelle 26a that houses components including a fuel cell system 26b, an electronic speed controller 26c, gimbal actuators (not shown), an electronics node 26f, sensors, and other desired electronic equipment. Nacelle 26a also supports a two-axis gimbal 26g and a propulsion system 26h depicted as an electric motor 26i and a rotor assembly 26j (not shown). As the power for each thrust module 26 is provided by fuel cell system 26b, housed within respective nacelles 26a, UAVs such as UAV 100 can have a distributed power system for a distributed thrust array. In this embodiment, electrical power may be supplied to any electric motor 26i, electronic speed controller 26c, electronics node 26f, gimbal actuators, flight control system, sensor, and/or other desired equipment from any fuel cell system 26b. Fuel cell system 26b is configured to produce electrical energy from an electrochemical reaction between hydrogen and oxygen. Fuel cell system 26b includes a fuel cell 26d which includes a cathode configured to receive oxygen from the ambient air, an anode configured to receive hydrogen fuel, and an electrolyte between the anode and the cathode that allows positively charged ions to move between the anode and the cathode. While fuel cell 26d is described in the singular, it should be understood that fuel cell 26d may include a fuel cell stack comprising a plurality of fuel cells in series or parallel to increase the output thereof. Fuel cell system 26b receives hydrogen fuel from fuel tank 25. Hydrogen fuel is delivered from fuel tank 25 to the anode of fuel cell 26d through a supply line 26t coupled to a pressure regulator 26u, which is coupled to stem 27 of tank 25. Pressure regulator 26u is configured to reduce the pressure of the hydrogen fuel from fuel tank 25 to a desired pressure in supply line 26t that is suitable for use at the anode of fuel cell 26d. Pressure regulator 26u may also have a filling port 26v coupled thereto. Filling port 26v is configured to enable refilling of fuel tank 25 without uncoupling tank 25 from nacelle 26a. Filling port 26v may allow for autonomous refilling of tank 25 when a UAV such as UAV 100 lands on a landing pad configured for the same. Alternatively, or additionally, thrust module 26 may include a pressure regulator 28u coupled to a stem 29 of tank 25, and a filling port 28v coupled to pressure regulator 28u. Filling port 28v extends from pressure regulator 28u to the exterior surface of tail section 28, thereby enabling refilling of tank 25 without uncoupling tank 25 from a tail section such as tail section 28.

Oxygen from the ambient air is delivered to the cathode of fuel cell 26d via an air channel 26w. Air channel 26w may serve two functions, supplying oxygen to the cathode and cooling fuel cell 26d. As such, air channel 26w is configured to direct air from outside of nacelle 26a to the cathode of fuel cell 26d and/or to a heat transfer surface of fuel cell 26d. The heat transfer surface of fuel cell 26d may comprise a heat exchanger or any surface configured to enhance heat removal therefrom. Moreover, when fuel cell 26d is an open-cathode air-cooled unit, the airflow delivered to the cathode by air channel 26w may serve as both the cathode reactant supply and cooling air. That is, air ducted to a single location may deliver oxygen to the cathode and cool fuel cell 26d. Air channel 26w includes a forward-facing opening 26x positioned behind rotor assembly 26j such that ram air and propeller wash is driven through air channel 26w by rotating rotor blades 26r. This is particularly helpful when a UAV such as UAV 100 is operating in the VTOL orientation, as it insures sufficient airflow for oxygen supply and/or cooling purposes. Fuel cell system 26b further includes an electrical energy storage device 26y configured to store and release the electrical energy produced by fuel cell 26d. Electrical energy storage device may comprise a battery, a supercapacitor, or any other device capable of storing and releasing electrical energy. Alternatively, the electrical energy produced by fuel cell 26d may be directly supplied to the electrical components.

Operation of fuel cell system 26b is controlled by electronics node 26f Electronics node 26f preferably includes non-transitory computer readable storage media including a set of computer instructions executable by one or more processors for controlling the operation of thrust module 26. These operations may include valve and solenoid operations to adjust the flow of hydrogen fuel from supply line 26t to the anode, battery management, directing electrical energy distribution, voltage monitoring of fuel cell 26d, current monitoring for fuel cell 26d and electrical energy storage device 26y, etc.

Referring back to FIG. 1, because forward flight of UAV 100 in the biplane orientation utilizing wing-borne lift requires significantly less power than VTOL flight utilizing thrust-borne lift, the operating speed of some or all of thrust modules 126 may be reduced. In certain embodiments, some of the thrust modules 126 could be shut down during forward flight. While UAV 100 may be reconfigured with different numbers or types of thrust modules 126 to satisfy different flight requirements, UAV 100 may also be configured to allow fuel cell system 26b to switch between operating on oxygen from ambient air and operating on oxygen provided by an on board oxygen tank such as the system disclosed in U.S. patent application Ser. No. 16/214,735, filed on Dec. 10, 2018, which is incorporated herein by reference in its entirety. Operating a fuel cell on oxygen, rather than air, can increase the power produced by the fuel cell, at sea level, by 15 to 20 percent. As such, the increased power of the oxygen mode may be used in the VTOL orientation and air mode may be used in the biplane orientation. It may be desirable for UAVs such as UAV 100 to have an oxygen tank that is remote from the thrust modules. Accordingly, a remote oxygen tank may be located anywhere on UAV 100, for example, one or more of tanks 125 may be configured to store and distribute pressurized oxygen to thrust modules 126 when needed. In this configuration, UAV 100 includes a supply line coupled between the remote oxygen tank and the cathode of fuel cell 26d. The supply line may be uninterrupted between the remote oxygen tank and the cathode, which would require a user to manually attached the supply line to the cathode when coupling thrust module 126 to UAV 100. Alternatively, the thrust module 126 and UAV 100 may include complimentary rapid connection interfaces that include not only electrical and mechanical connections, but also include gaseous connections for automated, or quick-connection, of separate portions of the supply line. The connections between wings 140 and 160, pylons 118 and 120, thrust modules 126, and payload 130 of UAV 100 are each operable for rapid on-site assembly through the use of high-speed fastening elements.

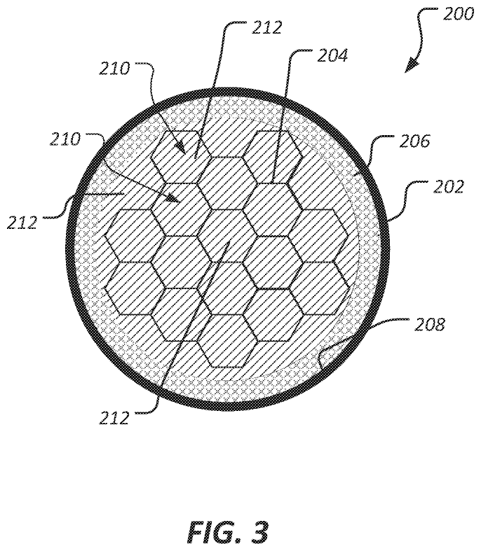

Referring now to FIG. 3, a cross-sectional view of a fuel tank 200 is shown. Fuel tank 200 is substantially similar to fuel tanks 125 and 25 at least insofar as it can be utilized as a portion of UAV 100 and/or as a portion of a thrust module 26. Most generally, fuel tank 200 comprises an exterior shell 202, an interior media guide 204, and a compliant layer 206 disposed adjacent an inner profile 208 of exterior wall 202. Exterior shell 202 can comprise metal, such as, but not limited to, steel or aluminum. Exterior shell 202 can generally be shaped as a cylinder having end caps with one of the end caps comprising a filling neck. Interior media guide 204 comprises a honeycomb-shaped profile that provides columnar segregation between adjacent cells 210 spaces defined by media guide 204. In some cases, compliant layer 206 can comprise one or more of metal aerogels, metallic foams, and/or honeycomb lattice structure. In some cases, space within fuel tank 200 that is located interior relative to the compliant layer 206, can be filled with media 212 such as, but not limited to, solid state hydride. In some cases, media 212 can comprise a power or granular form that can be poured into tank 200 both within cells 210 and into spaces between media guide 204 and compliant layer 206. In this embodiment, compliant layer 206 is substantially shaped as a cylindrical tube and is adhered to or lays adjacent inner profile 208. A length of compliant layer 206 is substantially similar to or longer than a length of media guide 204.

While compliant layer 206 can be a cylindrical tube, in alternative embodiments, a compliant layer can be formed in any other suitable shape, such as, but not limited to, conforming to any other inner profile of a fuel tank. For example, in alternative embodiments, a fuel tank can be shaped irregularly and/or as a component of a vehicle, such as a wing of an aircraft, and the compliant layer can complement and/or follow the inner profile or a portion of the inner profile. In other embodiments, multiple compliant layers can be provided that are not continuous along an inner profile. For example, a series of cylindrical tubular shaped compliant layers can be offset from each other and/or joined by a portion of compliant layer that is of a different thickness. This disclosure contemplates fuel tanks having any suitable number, degree, shape, thickness, composition (whether homogeneous or not) of compliant layers. Accordingly, one or more embodiments disclosed herein can accommodate physical expansion and contraction of media, including expansion and contraction that is predictable, unpredictable, repeated, permanent, symmetric, unsymmetric, fast and/or slow and in any direction. The expansion and contraction are accommodated by the at least partially elastic deformation of the compliant layer.

In some embodiments, this disclosure divulges a thermally conductive, mechanically compliant cylinder liner that can significantly reduce cylinder wall stress on a hydride storage cylinder. In some cases, solid state hydrogen media can volumetrically expand at least about 19-22%. Using a conventional heavy commercial aluminum solid state hydrogen storage cylinder, the media expansion can raise cylinder loads to 2,200 psi. However, by adding a thermally conductive, compliant layer between the tank walls and the hydride material, a cylinder with about one fourth the strength and mass (i.e. a thinner outer wall relative to the outer wall of the conventional tank) can be used to contain the hydride and the about 500 psi of hydrogen gas pressure. In some cases, the thinner wall can comprise a radius of about 10% greater relative to the conventional tank, but nonetheless still provide a mass savings of about 50-60%. This mass savings can translate to increased range, speed, and/or maneuverability of an aircraft or vehicle. It is important to note that the hydride media disclosed herein can be recharged with hydrogen to increase hydrogen content after hydrogen depletion. Most generally, heat transfer rates can be a limiting factor on recharging hydride media. Accordingly, it is important that the compliant layer be an efficient conductor of heat.

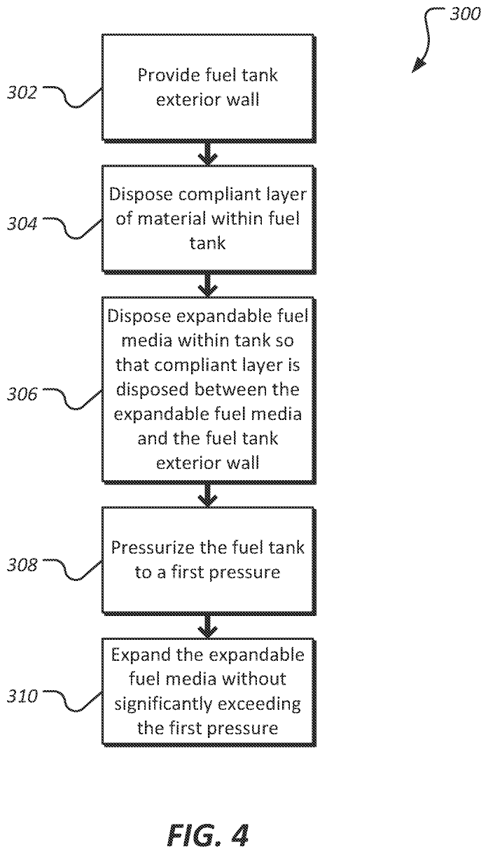

Referring now to FIG. 4, a flowchart of a method 300 of operating a fuel tank is shown. Method 300 can begin at block 302 by providing a substantially rigid fuel tank exterior wall. Next at block 304, the method 300 can progress by disposing a compliant layer of material within the fuel tank. At block 306, expandable fuel media can be disposed within the fuel tank so that the compliant layer is disposed between the expandable fuel media and the fuel tank exterior wall. Next at block 308, the fuel tank can be pressurized to accommodate a gas pressure. Finally, at block 310 the method 300 can continue by expanding the expandable fuel media without significantly exceeding the first pressure. It will be appreciated that the expansion of the fuel media is accommodated by the at least partially elastic deformation of the compliant layer.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A fuel tank, comprising:
an outer wall; and
a compliant layer disposed within a space at least partially defined by the outer wall;
wherein the compliant layer at least one of (1) contacts the outer wall and (2) is compressible.

2. The fuel tank of claim 1, wherein the compliant layer is configured for elastic deformation.

3. The fuel tank of claim 1, further comprising:
a media guide disposed within the space at least partially defined by the outer wall.

4. The fuel tank of claim 3, wherein the media guide is configured to provide a plurality of segregated columnar spaces.

5. The fuel tank of claim 1, wherein the compliant layer comprises a tubular shape.

6. The fuel tank of claim 5, wherein the compliant layer comprises a cylindrical shape.

7. The fuel tank of claim 1, wherein the compliant layer comprises at least one of metal aerogels, metallic foams, and/or a honeycomb lattice structure.

8. The fuel tank of claim 1, further comprising:
an expandable fuel media disposed within the fuel tank so that the compliant layer is disposed between the expandable fuel media and the outer wall.

9. The fuel tank of claim 8, wherein the expandable fuel media comprises solid state hydride.

10. An aircraft, comprising:
a fuel cell; and
a fuel tank, comprising:
an outer wall; and
a compliant layer disposed within a space at least partially defined by the outer wall;
wherein the compliant layer at least one of (1) contacts the outer wall and (2) is compressible.

11. A method of operating a fuel tank, comprising:
providing an external wall; and
disposing a compliant layer of material within a space of the fuel tank that is at least partially defined by the external wall;
wherein the compliant layer at least one of (1) contacts the outer wall and (2) is compressible.

12. The method of claim 11, further comprising:
disposing expandable fuel media within the fuel tank so that the compliant layer is disposed between the expandable fuel media and the external wall.

13. The method of claim 12, further comprising:
pressurizing the fuel tank to a first pressure.

14. The method of claim 13, further comprising:
expanding the expandable fuel media.

15. The method of claim 14, further comprising:
compressing the compliant layer.

16. The method of claim 15, further comprising:
contracting the expandable fuel media.

17. The method of claim 16, wherein the contracting is a function of recharging the expandable fuel media.

18. The method of claim 17, wherein the recharging comprises adding hydrogen to the expandable fuel media.

19. The method of claim 18, further comprising:
expanding the compliant layer.
